(19) United States
(12) Patent Application Publication
(10) Pub. No.: US 2014/0234543 A1
(43) Pub. Date: Aug. 21, 2014

(54) METHOD OF MANUFACTURING COATED SUBSTRATE

(71) Applicant: ASAHI GLASS COMPANY, LIMITED, Chiyoda-ku (JP)

(72) Inventors: Atsushi ITO, Tokyo (JP); Yosuke Takeda, Tokyo (JP)

(73) Assignee: ASAHI GLASS COMPANY, LIMITED, Chiyoda-ku (JP)

(21) Appl. No.: 14/263,272

(22) Filed: Apr. 28, 2014

Related U.S. Application Data
(63) Continuation of application No. PCT/JP2012/075757, filed on Oct. 4, 2012.

(30) Foreign Application Priority Data
Oct. 27, 2011 (JP) 2011-235665

(51) Int. Cl. B05D 3/10

(52) U.S. Cl. CPC B05D 3/107
USPC 427/341

(57) ABSTRACT

In a method of manufacturing a coated substrate having a coating film on a substrate, the method provides a highly durable coated substrate with high efficiency, while ensuring the storage stability of a coating film forming composition to be used. The method does not require a complicated processing. The resulting coated substrate is not deteriorated and has a good appearance. The method includes the steps of, preparing a coating film forming composition containing a silane compound having a hydrolyzable functional group, and not substantially containing a catalyst for hydrolysis reaction, applying the coating film forming composition on the substrate to form an applied film on the substrate, drying the applied film to obtain a precursor film, and treating a surface of the precursor film with a treatment solution to make the coating film on the substrate, the treatment solution containing a catalyst for hydrolysis reaction as a main component.

### CROSS-REFERENCE TO RELATED APPLICATIONS

This application is a continuation of prior International Application No. PCT/JP2012/075757, filed on Oct. 4, 2012 which is based upon and claims the benefit of priority from Japanese Patent Application No. 2011-235665 filed on Oct. 27, 2011; the entire contents of all of which are incorporated herein by reference.

### FIELD

The present invention relates to a method of manufacturing a coated substrate having a coating film on the substrate.

### BACKGROUND

Conventionally, a coated substrate is widely used in various purposes. In general, a coated substrate is obtained by forming a coating film on a substrate such as a glass substrate or a resin substrate. One of known methods for forming a coating film on a substrate uses a sol-gel method which has less strict conditions. The sol-gel method creates a coating film by utilizing the hydrolysis reaction of a silane compound having a hydrolyzable group. This method typically uses a coating film forming composition containing a catalyst such as acid or alkali, and a silane compound having a hydrolyzable group (refer to, for example, Patent Reference 1 (JP-A 2001-207162)). If the coating film forming composition should be stored in a long term, hydrolysis proceeds slowly over time, and the silane compound is polymerized in long-term storage. Thus, there is a problem in terms of storage stability.

In order to overcome the problem of storage stability, for example, Patent Reference 2 (JP-A 2001-205187) discloses use of the coating film forming composition that does not contain the catalyst. In Patent Reference 2, the coating film forming composition is applied on a substrate, the substrate is placed in an acid or alkali atmosphere, and the hydrolysis reaction takes place. However, the method of Patent Reference 2 requires a special equipment to form the alkali or acid atmosphere, and it entails a problem in terms of safety. Further, in this method, the entire substrate is exposed to an alkali or acid atmosphere while the coating film forming composition is applied on the substrate. Therefore, the substrate surface may deteriorate and the appearance may also deteriorate except for that substrate surface on which the coating film forming composition is applied.

A certain type of the silane compound has another problem. For example, when the fluorine-containing organic silicon compound is used, the coating film forming composition containing the fluorine-containing organic silicon compound and the alkali or acid catalyst is applied on a substrate, and then the subsequent hydrolysis reaction may require a long time humidification. This approach is disclosed in, for example, Patent Reference 3 (WO 2011/016458). As such, this approach needs an improvement in terms of production efficiency.

### SUMMARY

An object of the present invention is to provide a method of fabricating a coated substrate having a coating film on a substrate, that can ensure the storage stability of the coating film forming composition to be used, that has a good production efficiency, that does not require a complicated process, that can provide a good appearance without deterioration of the substrate, and that can impart a durability to the substrate.

The present invention provides a method of manufacturing a coated substrate having a configuration according to any one of the following aspects.

[1] A method of manufacturing a coated substrate having a coating film on a substrate, the method comprising the steps of:

preparing a coating film forming composition containing at least one kind of silane compound having a hydrolyzable functional group, and not substantially containing a catalyst for hydrolysis reaction;

applying the coating film forming composition on the substrate to form an applied film on the substrate;

drying the applied film to obtain a precursor film; and

treating a surface of the precursor film with a treatment solution to make the coating film on the substrate, the treatment solution containing a catalyst for hydrolysis reaction as a main component.

[2] The method of manufacturing a coated substrate according to [1], wherein the catalyst for hydrolysis reaction is an acid or alkali.
[3] The method of manufacturing a coated substrate according to [1], wherein the catalyst for hydrolysis reaction is an acid.
[4] The method of manufacturing a coated substrate according to [2], wherein the acid includes at least one acid selected from the group consisting of hydrochloric acid, nitric acid, sulfuric acid, paratoluenesulfonic acid, and methanesulfonic acid.
[5] The method of manufacturing a coated substrate according to [1], wherein the silane compound having the hydrolyzable functional group is a silane compound having a structure selected from a perfluoroalkyl group, a perfluoropolyether group and a polydimethylsiloxane chain.
[6] The method of manufacturing a coated substrate according to [1], wherein the hydrolyzable functional group is selected from an alkoxy group having 1 to 10 carbon atoms, an isocyanate group and a chlorine atom.
[7] The method of manufacturing a coated substrate according to [1], wherein the silane compound having the hydrolyzable functional groups includes a silane compound having a chlorine atom or an isocyanate group as the hydrolyzable functional group, and a silane compound having an alkoxy group as the hydrolyzable functional group.
[8] The method of manufacturing a coated substrate according to [1], wherein the treatment solution does not substantially contain a silane compound.
[9] The method of manufacturing a coated substrate according to [1], wherein the step of treating the surface of the precursor film with the treatment solution is carried out by moving a liquid holding member while the liquid holding member being in press contact with the surface of the precursor film, the liquid holding member being impregnated with the treating solution and holding the treating solution.
[10] The method of manufacturing a coated substrate according to [9], wherein a material of the liquid holding member is selected from a sponge, nonwoven fabric, woven fabric and paper.
[11] The method of manufacturing a coated substrate according to [1] further including the step of humidifying the precursor film at 0° C. to 60° C. and 50 RH % to 100 RH % for 10 minutes to 180 minutes prior to the step of treating the surface of the precursor film.
[12] The method of manufacturing a coated substrate according to [1], wherein a material of the substrate is a resin or glass.

According to the present invention, there is provided an improved process for manufacturing a coated substrate, that can ensure the storage stability of the coating film forming composition to be used, that has a good production efficiency, that does not require a complicated process, that can provide a good appearance without deterioration of the substrate, and that can impart a durability to the substrate.

### DETAILED DESCRIPTION

Now, preferred embodiments of the present invention will be described below. It should be noted that the present invention is not construed as being limited to the following description. A method of the embodiment according to the present invention is a method of manufacturing a coated substrate which has a coating film on a substrate, and includes the following steps (A) to (D).

(A) preparing a coating film forming composition that contains a silane compound having a hydrolyzable functional group, and does not substantially contain a catalyst for hydrolysis reaction (hereinafter referred to as coating film forming composition preparation step or step (A));
(B) applying the coating film forming composition on the substrate to form an applied film on the substrate (hereinafter referred to as applying step or step (B));
(C) drying the applied film to obtain a precursor film (hereinafter referred to as drying step or step (C)); and
(D) treating a surface of the precursor film with a treatment solution to make the coating on the substrate, the treatment solution containing, as a main component thereof, a catalyst for hydrolysis reaction (hereinafter referred to as catalyst treatment step or step (D)).

Preferably the manufacturing method of the embodiment according to the present invention may include, between the step (C) and step (D), a step of humidifying the precursor film on the substrate, which is prepared by the step (C), at 0° C. to 60° C. and 50 RH % to 100 RH % for 10 minutes to 180 minutes (hereinafter, referred to as humidifying step or step (C-1)). The manufacturing method of the embodiment according to the present invention may also include a step of heating the precursor film on the substrate at a temperature above 60° C. as needed between the step (C) and step (D) (hereinafter, the heating step or step (C-2)). The coated substrate may also have an intermediate film, which possesses various functions, between the coating film and the substrate. With such configuration, the surface on which the coating film forming composition is applied in the step (B) is not the substrate surface but the surface of the intermediate film formed on the substrate surface.

In the silane compound having a hydrolyzable functional group (referred to as “hydrolyzable group”), the hydrolyzable group bound to a silicon atom or atoms is hydrolyzed in the presence of a catalyst and water, and generates a hydroxyl group (silanol group) that is bound to the silicon atom. Then, silanol groups undergo dehydration condensation with each other, and produce a siloxane bond which is represented by —Si—O—Si— to have a high molecular weight. When the silane compound having a chlorine atom as the hydrolyzable group is used, i.e., when a chlorosilane is used, a silanol group and a chlorine atom of the chlorosilane produce a siloxane bond by a dehydrochlorination reaction in many cases. Hereinafter a silane compound having a hydrolyzable group is referred to as “hydrolyzable silane compound”. The hydrolytic condensation of the hydrolyzable silane compound produces linear polysiloxane or polysiloxane having a three-dimensional network structure, which becomes the coating on the substrate, depending upon the number of hydrolyzable groups bound to the silicon atom. The hydrolyzable silane compound includes a hydrolyzable silane compound that has one or more silicon atoms, and partially hydrolyzed condensate which is prepared from such hydrolyzable silane compound alone or a combination of such hydrolyzable silane compounds.

When the conventional method is used to form a coating film on a substrate, a coating film forming composition containing a solvent, a catalyst for hydrolysis reaction and a hydrolyzable silane compound is applied on the substrate. After the drying the composition or at the same time as the drying the composition, the coating film forming composition is cured to obtain the coating film by causing the hydrolysis condensation. In the manufacturing method of the embodiment according to the present invention, no catalyst for hydrolysis reaction is contained in the coating film forming composition. A precursor film is prepared by drying the applied film, and then the coating film is formed on the substrate by using the action of the catalyst for hydrolysis reaction on the precursor film surface. This method ensures the storage stability of the coating film forming composition, has an improved production efficiency, does not require complicated processes, does not deteriorate the substrate, and imparts a good appearance to the substrate.

The coating film to which the manufacturing method of the embodiment according to the present invention is applied is not limited to a particular coating film as long as the coating film is primarily formed by a siloxane bond. In order to provide the coating film with various functions, the coating film to which the embodiment according to the present invention is applied includes a coating film that is formed by using a hydrolyzable silane compound having various functional groups introduced in addition to (or other than) hydrolyzable groups bound to the silicon atom. In particular, if the coating film is formed by using a hydrolyzable silane compound having a fluorine-containing organic group in order to impart water repellency to the coating film, the manufacturing method of the embodiment according to the present invention is preferably used because the water-repellent film is required to have long durability.

As used in this specification, the term “applied film” means a film that results from the coating film forming composition applied. The term “precursor film” means a film that is obtained by drying the applied film. The term “coating film” means a film obtained by curing the precursor film by hydrolytic condensation. As used herein, the term “(meth)acryloyloxy . . . ” such as that used in the (meth)acryloyloxy group means both “acryloyloxy . . . ” and “methacryloyloxy . . . .” The term “(meth)acryl . . . ” means both “acryl . . . ” and “methacryl . . . .” As used herein, a compound represented by the formula (1A) is referred to as a compound (1A). Other compounds are referred to in the same manner. As used herein, the group represented by the formular (A) is referred to as a group (A). The same applies to other groups.

The steps of the manufacturing method will be described below.

### (A) Coating Film Forming Composition Preparation Step

The coating film forming composition is a composition to form an applied film, which contains a hydrolyzable silane compound, on the substrate. The coating film forming composition contains a hydrolyzable silane compound. Usually, the coating film forming composition contains a solvent to ensure the applicability of the composition onto the substrate. The coating film forming composition used in the embodiment according to the present invention does not substantially contain a catalyst for hydrolysis reaction.

### (Hydrolyzable Silane Compound)

The hydrolyzable silane compound is not limited to a particular compound as long as the hydrolyzable silane compound is capable of forming a coating film by siloxane bonds. One exemplary hydrolyzable silane compound has 1 to 4 hydrolyzable groups bound to four atomic bondings of a silicon atom and also has a hydrogen atom or an organic group bound to the remaining atomic bondings. It should be noted that the film formation is difficult if the hydrolyzable silane compound having a single hydrolyzable group is used alone. Thus, such hydrolyzable silan compound is used in combination with the hydrolyzable silane compound having two or more hydrolyzable groups.

Examples of the hydrolyzable group possessed by the hydrolyzable silane compound are an alkoxy group having 1 to 10 carbon atoms, oxyalkoxy groups having 2 to 10 carbon atoms, acyloxy group having 2 to 10 carbon atoms, alkenyloxy group having 2 to 10 atoms, a halogen atom or an isocyanate group. Among these, an alkoxy group having 1 to 10 carbon atoms, an isocyanate group and a chlorine atom are preferred. It should be noted that if there are a plurality of hydrolyzable groups in one molecule, the hydrolyzable groups may be the same as each other or different from each other.

A fluorine-containing hydrolyzable silane compound used as the hydrolyzable silane compound to form a fluorine-containing coating film will be described below, and a hydrolyzable silane compound having no fluorine atom will also be described. Examples of the fluorine-containing hydrolyzable silane compound are a hydrolyzable silane compound having a fluorine-containing polyether group, a hydrolyzable silane compound having a fluorine-containing alkyl group, and a silane compound having a polydimethyl siloxane chain structure to which a fluorine-containing organic group is bound. A preferred example of the fluorine-containing polyether group is a perfluoropolyether group, and a preferred example of the fluorine-containing alkyl group is a perfluoroalkyl group.

Examples of the hydrolyzable silane compounds having no fluorine atom are an organosilane compound having a hydrolyzable group, and a silane compound having a polydimethylsiloxane chain structure. Both of these compounds have no fluorine atom.

Among these, preferred is a silane compound having a structure selected from the perfluoroalkyl group, the perfluoropolyether group and the polydimethylsiloxane chain.

### (1) Hydrolyzable Silane Compound Having a Perfluoropolyether Group

Examples of the silane compound having a hydrolyzable group and a perfluoropolyether group are, in particular, the compounds represented by the following formula (1A) and the following formula (1B).

A¹-Q¹-SiX¹ₘR¹₃₋ₘ (1A)

A¹-Q¹-{CH₂CH(SiX¹ₘR¹₃₋ₘ)}ₙ—H (1B)

The meaning of the symbols in the formulas (1A) and (1B) is as follows.

A¹: a group represented by the formula (A).

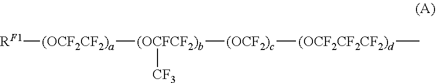

In the formula (A), R^{F1} represents a perfluoroalkyl group. a, b, c and d are independent and each of them represents an integer of 0, 1 or more. The sum of a, b, c and d i.e. a+b+c+d is one or more. The presence order of the repeating units denoted by the suffix a, b, c and d using the parentheses is not limited in the formula.

Q¹: a divalent organic group having 2 to 12 carbon atoms having repeating —CH₂— units, that may contain one or two kinds of group selected from an amide bond selected from —C(═O)NH—, —C(═O)N(CH₃)— and —C(═O)N(C₆H₅)—, a urethane bond, an ether bond, an ester bond, —CF₂— group and a phenylene group. It should be noted that one of the hydrogen atoms of the —CH₂— group may be substituted with —OH group. In the following description, —C(═O)N . . . will be expressed by —CON . . . . For example, —C(═O)NH— will be expressed by —CONH—.

X¹: an alkoxy group having 1 to 10 carbon atoms, an oxyalkoxy groups having 2 to 10 carbon atoms, an acyloxy group having 2 to 10 carbon atoms, an alkenyloxy group having 2 to 10 carbon atoms, a halogen atom or an isocyanate group. The m X¹ may be the same as or different from one another.

R¹: a hydrogen atom, or a monovalent hydrocarbon group having 1 to 8 carbon atoms (for example, an alkyl group, an alkenyl group, or an aryl group), where some or all of the hydrogen atoms may be substituted in the monovalent hydrocarbon group. The 3-m R¹ may be the same as or different from one another.
m: 1, 2 or 3
n: an integer of 1 to 10

With regard to A¹ in the compound (1A) and the compound (1B), the upper limits of a, b, c, and d are independent from each other, and preferably 200 and more preferably 50. The upper limit of a+b+c+d is preferably 200 and more preferably 100. Examples of the A¹ are R^{F1}—(OCF₂)_{c}—, R^{F1}—(OCF₂CF₂)ₐ—(OCF₂)_{c}, R^{F1}—(OCF₂CF₂)ₐ, R^{F1}—(OCF₂CF₂CF₂)_{d}, R^{F1}—{(OCF(CF₃)CF₂)_{b}, and the like.

Examples of Q¹ in the compound (1A) and the compound (1B) are —(CH₂)ₙ₁— (“n1” is an integer of 2 to 4), —CONH(CH₂)ₙ₂— (“n2” is an integer of 2 to 4), —(CF₂)ₙ₃—, —O—(CF₂)ₙ₃— (“n3” is an integer of 2 to 4), —CH₂OCONHC₃H₆—, —COCH₂CH(OH)CH₂OC₃H₆—, —CH₂OCH₂CH(OH)CH₂OC₃H₆—, —CH₂OC₃H₆—, —CF₂OC₃H₆—, and the like. Among these, the preferred Q¹ is a divalent organic group selected from —CONHC₃H₆—, —CONHC₂H₄—, —CH₂OCONHC₃H₆—, —COCH₂CH(OH)CH₂OC₃H₆—, —CH₂OCH₂CH(OH)CH₂OC₃H₆—, —CH₂OC₃H₆—, —CF₂OC₃H₆—, —C₂H₄—, —C₃H₆—, —C₂F₄— and —OC₂F₄—. More preferably, —CONHC₃H₆—, —CONHC₂H₄—, or —C₂H₄— is used.

Examples of X¹ in the compound (1A) and the compound (1B) are a methoxy group, an ethoxy group, n-propoxy group, an isopropoxy group, an n-butoxy group, an isobutoxy group, a sec-butoxy group, a tert-butoxy group, a phenoxy group, a chlorine atom, a bromine atom, an isocyanate group, and the like. Among these, the alkoxy group having 1 to 10 carbon atoms, the isocyanate group and the chlorine atom are preferred, and the methoxy group and the ethoxy group are particularly preferred. “m” is preferably 2 or 3.

Examples of R¹ in the compound (1A) and the compound (1B) are a hydrogen atom, a methyl group, an ethyl group, an n-propyl group, an isopropyl group and the like. Among these, the hydrogen atom, the methyl group, the ethyl group, and the like are preferred.

More specific examples of the compound represented by the formula (1A) are the following compounds (1A-1) to (1A-5).

CF₃—(OCF₂)_{c}-Q¹-SiX¹ₘR¹₃₋ₘ (1A-1)

CF₃—(OCF₂CF₂)ₐ—(OCF₂)_{c}-Q¹-SiX¹ₘR¹₃₋ₘ (1A-2)

CF₃CF₂—(OCF₂CF₂)ₐ-Q¹-SiX¹ₘR¹₃₋ₘ (1A-3)

CF₃CF₂CF₂—(OCF₂CF₂CF₂)_{d}-Q¹-SiX¹ₘR¹₃₋ₘ (1A-4)

CF₃CF₂CF₂—{OCF(CF₃)CF₂}_{b}-Q¹-SiX¹ₘ—R¹₃₋ₘ (1A-5)

More specific examples of the compound represented by formula (1B) are the following compounds (1B-1) to (1B-5).

CF₃—(OCF₂)_{c}-Q¹-{CH₂CH(SiX¹ₘR¹₃₋ₘ)}ₙ—H (1B-1)

CF₃—(OCF₂CF₂)ₐ—(OCF₂)_{c}-Q¹-{CH₂CH(SiX¹ₘR¹₃₋ₘ)}ₙ—H (1B-2)

CH₃CF₂—(OCF₂CF₂)ₐ-Q¹-{CH₂CH(SiX¹ₘR¹₃₋ₘ)}ₙ—H (1B-3)

CF₃CF₂CF₂—(OCF₂CF₂CF₂)_{d}-Q¹-{CH₂CH(SiX¹ₘR¹₃₋ₘ)}ₙ—H (1B-4)

CF₃CF₂CF₂—{OCF(CF₃)CF₂}_{b}-Q¹-{CH₂CH(SiX¹ₘR¹₃₋ₘ)}ₙ—H (1B-5)

The symbols in the formulas (1A-1) to (1A-5) and formulas (1B-1) to (1B-5) are independent from each other, are the same as those in the formula (1A) and formula (1B) respectively, and preferred examples and values are also the same as those described above.

Among these, the compounds (1A-2) are preferred, and the following compounds are particularly preferred among them.

CF₃—(OCF₂CF₂)ₐ—OCF₂—CONHC₃H₆Si(OCH₃)₃

CF₃—(OCF₂CF₂)ₐ—OCF₂—CONHC₃H₆Si(OC₂H₅)₃

CF₃—(OCF₂CF₂)ₐ—OCF₂—CONHC₂H₄Si(OCH₃)₃

CF₃—(OCF₂CF₂)ₐ—OCF₂—CONHC₂H₄Si(OC₂H₅)₃

CF₃—(OCF₂CF₂)ₐ—OCF₂—C₂H₄Si(OCH₃)₃

CF₃—(OCF₂CF₂)ₐ—OCF₂—C₂H₄Si(OC₂H₅)₃

In all of the above-identified compounds, “a” is 7 to 8, and the average of “a” is 7.3. Among these compounds, CF₃(OCF₂CF₂)ₐOCF₂CONHC₃H₆Si(OCH₃) is preferred.

The compounds (1A) and (1B) may be prepared by known methods. For example, the compound (1A-2) may be manufactured by the method described in WO2009-008380. The compound (1B) may be manufactured by the method described in JP-A 1997-157388.

The silane compound having a perfluoropolyether group and a hydrolyzable group may be a perfluoropolyether residue containing polyorganosiloxane represented by the formula (2).

W²¹ₛ₁(R²¹)ₜ₁Z²¹-Q²¹-A²-Q²²-Z²²(R²²)ₜ₂W²²ₛ₂ (2)

In the formula (2), A² is a divalent perfluoropolyether residue. Q²¹ and Q²² are independent, and each of them is a divalent organic group having 2 to 12 carbon atoms having repeating —CH₂— units, that may contain one or two kinds of group selected from an amide bond selected from —CONH—, —CON(CH₃)— and —CON(C₆H₅)—, a urethane bond, an ether bond, an ester bond, —CF₂— group and a phenylene group. It should be noted that one of the hydrogen atoms of the —CH₂— group may be substituted with a —OH group. Z²¹ and Z²² are independent, and each of them is a trivalent to undecavalent polyorganosiloxane residue having 3 or more siloxane bonds. R²¹ and R²² are independent, and each of them is a monovalent alkyl group having 8 to 40 carbon atoms. t1 and t2 are independent, and each of them is an integer of 1 to 8. W²¹ and W²² are independent, and each of them is a group expressed by the formula (W). s1 and s2 are independent, and each of them is an integer of 1 to 9, where s1+t1=(valence of Z²¹−1), and s2+t2=(valence of Z²²−1).

—(CH₂)ₚSiX²ₘR²³₃₋ₘ (W)

In the formula (W), X² is an alkoxy group having 1 to 10 carbon atoms, an oxyalkoxy group having 2 to 10 carbon atoms, an acyloxy group having 2 to 10 carbon atoms, an alkenyloxy group having carbon atoms 2-10, a halogen atom, or an isocyanate group. Among these, the alkoxy group having 1 to 10 carbon atoms, the isocyanate group and the chlorine atom are preferred. The m X² may be the same as or different from each other.

R²³ is an alkyl group having 1 to 4 carbon atoms or a phenyl group. The 3-m R²³ may be the same as or different from each other. “m” is 1, 2 or 3, and “p” is an integer of 2 to 10.

Examples of A² are groups represented by the following general formula (A3), (A4) or (A5).

—(CF₂)ₑ₁(OCF₂CFY)_{f}O{(CF₂)_{g}O)}ₕ(CFYCF₂O)ᵢ(CF₂)ₑ₂— (A3)

In the formula (A3), Y represents independently a fluorine atom or CF₃ group. “e1” is an integer of 1 to 3, “e2” is an integer of 1 to 3, “g” is an integer of 2 to 6, “f” is an integer of 0 to 100, “i” is an integer of 0 to 100, f+i is an integer of 2 to 100, and “h” is an integer of 0 to 6. The sequence of the repeating units may be random.

—(CF₂)ₑ₃(OCF₂CF₂CF₂)ⱼO(CF₂)ₑ₄— (A4)

In the formula (A4), “j” is an integer of 1 to 100, “e3” is an integer of 1 to 3, and “e4” is an integer of 1 to 3.

—(CF₂)ₑ₅(OCF₂CFY)ₖ(OCF₂)ₗO(CF₂)ₑ₆— (A5)

In the formula (A5), Y represents a fluorine atom or a CF₃ group, “e5” is an integer of 1 to 3, “e6” is an integer of 1 to 3, “k” is an integer of 0 to 100, “l” is an integer of 0 to 100, and k+1 is 2 to 100. The sequence of the repeating units may be random.

In the silane compound represented by the formula (2), preferably A² is a group represented by the formula (A6).

—CF₂—(OCF₂CF₂)ₓ—(OCF₂)_{y}—OCF₂— (A6)

In the formula (A6), “x” is an integer of 0 to 50, “y” is an integer of 1 to 50, and x+y is an integer of 2 to 60.

The compound (2) may be fabricated by a known method, e.g., the method disclosed in JP-B 4,666,667.

### (2) Hydrolyzable Silane Compound Having a Perfluoroalkyl Group

An example of a silane compound having a perfluoroalkyl group and a hydrolyzable group is a compound represented by the formula (3).

CF₃—(CF₂)ᵣ-Q³-SiR³₃₋ₘX³ₘ (3)

The symbols in the formula (3) are as follows.

r: an integer of 0 to 19

Q³: a divalent organic group containing no fluorine atom having 1 to 10 carbon atoms

m: 1, 2 or 3

R³: a hydrogen atom or a monovalent hydrocarbon group having 1 to 8 carbon atoms (for example, an alkyl group, an alkenyl group, or an aryl group). In the monovalent hydrocarbon group, some or all of the hydrogen atoms may be substituted. The 3-m R³ may be the same as or different from one another.

X³: an alkoxy group having 1 to 10 carbon atoms, an oxyalkoxy group having 2 to 10 carbon atoms, an acyloxy group having 2 to 10 carbon atoms, an alkenyloxy group having 2 to 10 carbon atoms, a halogen atom, or an isocyanate group. Among these, preferred are an alkoxy group having 1 to 10 carbon atoms, an isocyanate group, and a chlorine atom. The m X³ may be the same as or different from one another.

Examples of Q³ is a divalent organic group selected from —(CH₂)ₙ₄ (“n4” is an integer of from 1 to 10, and preferably an integer of from 1 to 6), —CONH(CH₂)ₙ₅ (“n5” is an integer of from 1 to 9, and preferably an integer of from 1 to 5), and —CONH(CH₂)ₙ₆NH(CH₂)ₙ₇ (“n6” is an integer of from 1 to 8, and preferably an integer from 1 to 4, “n7” is 9—n6, and preferably 5—n6). Among these, —(CH₂)₂, —CONH(CH₂)₃, —CONH(CH₂)₂NH(CH₂)₃ and the like are preferred.

Compound represented by the following formulas (3-1) to (3-6) are preferred as the hydrolyzable silane compound having a perfluoroalkyl group represented by the formula (3).

CF₃—(CF₂)ᵣ(CH₂)ₙ₄SiX³₃ (3-1)

CF₃—(CF₂)ᵣ(CH₂)ₙ₄Si(R³)X³₂ (3-2)

CF₃—(CF₂)ᵣCONH(CH₂)ₙ₅SiX³₃ (3-3)

CF₃—(CF₂)ᵣCONH(CH₂)ₙ₅Si(R³)X³₂ (3-4)

CF₃—(CF₂)ᵣCONH(CH₂)ₙ₆NH(CH₂)₅₋ₙ₆SiX³₃ (3-5)

CF₃—(CF₂)ᵣCONH(CH₂)ₙ₆NH(CH₂)₅₋ₙ₆Si(R³)X³₂ (3-6)

X³ and R³ in the formulas (3-1) to (3-6) represent the same meaning as the above formula as in the formula (3), and the preferred examples are also the same. “r” is an integer of from 1 to 19, “n4” is an integer of from 1 to 6, “n5” is an integer of from 1 to 5, and “n6” is an integer of from 1 to 4.

Among these, the compounds (3-1) are preferred from the viewpoint of weather resistance in an outdoor application, and the following compounds are particularly preferred among them.

C₆F₁₃CH₂CH₂Si(OCH₃)₃

C₈F₁₇CH₂CH₂Si(OCH₃)₃

C₆F₁₃CH₂CH₂SiCl₃

C₈F₁₇CH₂CH₂SiCl₃

C₆F₁₃CH₂CH₂Si(NCO)₃

C₈F₁₇CH₂CH₂Si(NCO)₃

The compounds (3) may be prepared by a general method. There are commercially available compounds (3), and the use of such commercially available products in the embodiment according to the present invention are admissible.

(3) Hydrolyzable Silane Compound Having Polydimethylsiloxane Chain to which Fluorine-Containing Organic Group is Bound

Examples of the silane compound that possesses a polydimethylsiloxane chain having a hydrolyzable group to which the fluorine-containing organic group is bound are compounds represented by the formula (4).

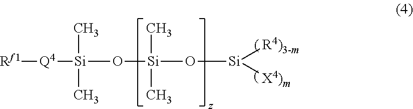

In the formular (4), R^{f1} is a monovalent organic group having 1 to 20 carbon atoms containing a fluorine atom, Q⁴ is an alkylene group, “z” is an integer of from 0 to 100, R⁴ is a monovalent hydrocarbon group having 1 to 5 carbon atoms, X⁴ is a hydrolyzable group, and “m” is 2 or 3.

Preferably R^{f1} is a monovalent polyfluorohydrocarbon group. The “monovalent polyfluorohydrocarbon group” is a monovalent hydrocarbon group that has at least two hydrogen atoms substituted with fluorine atoms. The number of carbon atoms of R^{f1} is 1 to 20, and preferably 4 to 16, and particularly preferably 4 to 12. Preferably R^{f1} is a polyfluoroalkyl group.

If the number of fluorine atoms in R^{f1} is expressed by (number of fluorine atoms in the polyfluorohydrocarbon group)/(number of hydrogen atoms in the hydrocarbon groups having the same number of carbon atoms corresponding to the polyfluorohydrocarbon group)×100(%), then it is preferably 60% or more, and particularly preferably 80% or more. R^{f1} is preferably a perfluorinated hydrocarbon group (all hydrogen atoms in the hydrocarbon group are substituted with fluorine atoms), and particularly preferably a perfluoroalkyl group.

The structure of R^{f1} may be a branched structure or a straight-chain (linear) structure, and it is preferably the straight-chain structure. In the case of the branched structure, the branch portion preferably has 1 to 3 carbon atoms (i.e., the short chain is preferred), and the branch portion is preferably located in the vicinity of the end of R^{f1}.

Examples of R^{f1} are shown below. These examples may provide a group of structural isomerism having the same molecular formula. C₄F₉— (for example, F(CF₂)₄—, (CF₃)₂CFCF₂—, (CF₃)₃C—, CF₃CF₂CF(CF₃)—, or the like), C₅F₁₁— (for example, F(CF₂)₅—, (CF₃)₂CF(CF₂)₂—, (CF₃)₃CCF₂—, CF₃(CF₂)₂CF(CF₃)—, or the like), C₆F₁₃—, C₈F₁₇—, C₁₀F₂₁—, C₁₂F₂₅—, C₁₄F₂₉—, C₁₆F₃₃—, C₁₈F₃₇—, C₂₀F₄₁—, or the like.

Q⁴ is preferably —(CH₂)_{q}—. “q” is an integer of 2 or more. “q” is preferably an integer of 2 to 6, and particularly preferably 2 or 3. That is, the particularly preferred Q⁴ is —CH₂CH₂— or —CH₂CH₂CH₂—. “z” is an integer of 0 to 100, is preferably 1 to 50, and particularly preferably 2 to 30.

R⁴ is a monovalent hydrocarbon group having 1 to 5 carbon atoms. R⁴ is preferably an alkyl group having 1 to 5 carbon atoms. For example, R⁴ is a methyl group, an ethyl group, an n-propyl group, an isopropyl group, an n-butyl group, an isobutyl group, a sec-butyl group, or the like. The 3-m R⁴ may be the same as or different from each other.

X⁴ is a hydrolyzable group. Specifically, X⁴ is an alkoxy group having 1 to 10 carbon atoms, an oxyalkoxy group having 2 to 10 carbon atoms, an acyloxy group having 2 to 10 carbon atoms, an alkenyloxy group having 2 to 10 carbon atoms, a halogen atom, or an isocyanate group. Among these, —OR⁴¹ (R⁴¹ is a monovalent hydrocarbon group having 1 to 10 carbon atoms that may contain a oxygen atom), a chlorine atom, and an isocyanate group are preferred, and an alkoxy group having 1 to 10 carbon atoms, a chlorine atom, and an isocyanate group are particularly preferred. Preferred examples of —OR⁴¹ are, for example, a methoxy group, an ethoxy group, an n-propoxy group, an isopropoxy group, an isopropenoxy group, an n-butoxy group, and an acetoxy group. The m X⁴ may be the same as or different from each other. “m” is 1, 2 or 3, and preferably 2 or 3.

In a preferred example of the fluorine-containing organic silicon compound of the embodiment according to the present invention, R^{f1} is C₈F₁₇— (including a group of structural isomerism), Q⁴ is —CH₂CH₂—, “z” is from 9 to 48, “m” is 3, and all of three X⁴ are a methoxy group, a chlorine atom or an isocyanate group.

The compound (2) may be prepared by a known method, for example, the method disclosed in JP-A 2002-121286.

### (4) Hydrolyzable Silane Compound Having No Fluorine Atom

A specific example of the hydrolyzable silane compound having no fluorine atom is a hydrolyzable silane compound represented by the general formula (5), or a hydrolyzable silane compound having a polydimethyl siloxane chain which includes CH³—, OH—, R⁴₃₋ₘX⁴ₘSi—O— or the like bound instead of the R^{f}-Q⁴- in the formular (4).

R⁵¹ᵥSiR⁵²_{w}(X⁵)_{4-v-w} (5)

In the formula (5), R⁵¹ is a substituted or no-substituted monovalent hydrocarbon group having 1 to 18 carbon atoms, R⁵² is an alkyl group or aryl group having 1 to 18 carbon atoms, X⁵ is an alkoxy group having 1 to 10 carbon atoms, an oxyalkoxy group having 2 to 10 carbon atoms, an acyloxy group having 2 to 10 carbon atoms, an alkenyloxy group having 2 to 10 carbon atoms, a halogen atom, or an isocyanate group. Each of “v” and “w” is 0, 1 or 2, and v+w is 0, 1 or 2.

In the formula (5), specific examples of R⁵¹ is an alkyl group, an aryl group, a halogenated alkyl group other than fluorine, a halogenated aryl group other than fluorine, or an alkenyl group, having 1 to 18 carbon atoms. Another example of R⁵¹ is a substituted monovalent hydrocarbon group that has a suitable one of the above-mentioned groups with its hydrogen atoms being entirely or partly substituted with a certain substituent such as a (meth)acryloyloxy group, a mercapto group, an amino group, a cyano group, or an epoxy group.

More specifically, R⁵¹ may be an alkyl group such as a methyl group, an ethyl group, a propyl group, an isopropyl group, a butyl group, a hexyl group, a decyl group, and a cyclohexyl group. Alternatively, R⁵¹ may be an aryl group such as a phenyl group and a phenethyl group, or a halogenated arkyl group other than fluorine such as 3-chloropropyl group. Alternatively, R⁵¹ may be a halogenated aryl group other than fluorine such as a p-chlorophenyl group. Alternatively, R⁵¹ may be an alkenyl group such as a vinyl group, an allyl group, 9-decenyl group and a p-vinylbenzyl group. Alternatively, R⁵¹ may be a (meth)acryloyloxy group-containing organic group such as 3-(meth)acryloyloxy propyl group, or a mercapto group-containing organic group such as a 3-mercaptopropyl group and a p-mercaptomethylphenyl ethyl group. Alternatively, R⁵¹ may be an amino group-containing organic group such as a 3-amino propyl group and a (2-aminoethyl)-3-amino propyl group, or a cyano group-containing organic group such as a 2-cyanoethyl group. Alternatively, R⁵¹ may be an epoxy group-containing organic group such as a 3-glycidoxypropyl group and a 2-(3,4-epoxycyclohexyl)ethyl group.

In the embodiment according to the present invention, R⁵¹ is preferably a 3-glycidoxypropyl group, a 2-(3,4-epoxy cyclohexyl)ethyl group, or a 3-(meth)acryloyloxypropyl group. Groups having such organic group are capable of having an organic bond other than siloxane bond, and are preferable for obtaining a room temperature curing properties. In the formular (5), the number of R⁵¹ bound to the silicon atom, which is represented by “v”, is 0, 1, or 2. When “v” is 2, two R⁵¹ may be the same as or different from each other. In the embodiment according to the present invention, “v” is preferably zero from the viewpoint of abrasion resistance.

In the formula (5), R⁵² is an aryl group or an alkyl group having 1 to 18 carbon atoms. Specific examples of R⁵² include a methyl group, an ethyl group, a propyl group, a hexyl group, a decyl group, an octadecyl group, and a phenyl group. Preferably R⁵² is an alkyl group having 4 or less carbon atoms. In the formula (5), the number of R⁵² bound to the silicon atom which is represented by w is 0, 1, or 2. When “w” is 2, two R⁵² may be the same as or different from each other. In the embodiment according to the present invention, “w” is preferably zero from the viewpoint of abrasion resistance.

Among X⁵ in the formula (5), the alkoxy group having 1 to 10 carbon atoms, an oxyalkoxy group having 2 to 10 carbon atoms, an acyloxy group having 2 to 10 carbon atoms, and an alkenyloxy group having 2 to 10 carbon atoms are groups represented by —OR⁵³ (R⁵³ is a monovalent hydrocarbon group having 1 to 10 carbon atoms, that may contain an oxygen atom). Examples of such monovalent hydrocarbon group are an alkyl group having 1 to 10 carbon atoms, an alkenyl group having 2 to 10 carbon atoms, a cycloalkyl group having 5 or 6 carbon atoms, an acyl group having 2 to 10 carbon atoms, and an aralkyl group having 7 to 10 carbon atoms. Specific examples of the monovalent hydrocarbon group include a methyl group, an ethyl group, a propyl group, an isopropyl group, a butyl group, a hexyl group, an isopropenyl group and the like. Examples of the monovalent hydrocarbon group containing an oxygen atom include an alkoxyalkyl group, an acyloxy alkyl group, an alkoxycarbonyl alkyl group, having 2 to 10 carbon atoms, and the like. Specific examples of the monovalent hydrocarbon group containing an oxygen atom are a 2-methoxyethyl group, an acetyl group, and the like.

Among these, X⁵ is preferably an alkoxy group having 1 to 10 carbon atoms, a chlorine atom, or an isocyanate group. In terms of hydrolysis rate and stability of the coating film forming composition, particularly preferred are a methoxy group, an ethoxy group, an isopropoxy group, a tert-butoxy group or other alkoxy groups having 4 or less carbon atoms.

In the formula (5), the number of R⁵¹, R⁵² bound to the silicon atom which is represented by “v” and “w”, is 0, 1 or 2. Because v+w is 0, 1 or 2, the number of X⁵ bound to the silicon atom in the formula (5) represented by 4−v−w is 4, 3 or 2. In this case, although 2 to 4 X⁵ may be different, they are preferably identical in terms of uniform reaction.

Examples of the tetrafunctional, trifunctional or bifunctional alkoxysilane compounds, which are preferably used as the hydrolyzable silane compound having no fluorine atom represented by the formula (5), are shown below.

The preferred examples of the bifunctional alkoxysilane compound include a dimethyl dimethoxysilane, a dimethyl diethoxysilane, a diphenyl dimethoxysilane, a diphenyl diethoxysilane, a phenyl methyl dimethoxysilane, a phenyl methyl diethoxysilane, a 3-glycidoxypropyl methyl dimethoxysilane, a 3-glycidoxypropylmethyldiethoxysilane, a 3-(meth)acryloyloxypropyl methyldimethoxysilane, a 3-(meth)acryloyloxy propyl methyl diethoxysilane, a 3-aminopropyl methyl dimethoxysilane, a 3-aminopropylmethyldiethoxysilane and the like.

The preferred examples of the trifunctional alkoxysilane compound include a methyl trimethoxysilane, methyl triethoxysilane, a methyl triisopropoxysilane, a methyl tri tert-butoxysilane, an ethyl trimethoxysilane, an ethyl triethoxysilane, an ethyl triisopropoxysilane, an ethyltri tri-tert-butoxysilane, a vinyl trimethoxysilane, a vinyl triethoxysilane, a vinyl triisopropoxysilane, a vinyl tri tert-butoxysilane, an n-propyl trimethoxysilane, an n-propyl triethoxysilane, an n-propyl triisopropoxysilane, an n-propyl tri tert-butoxysilane, an n-hexyl trimethoxysilane, an n-hexyl triethoxysilane, an n-hexyl triisopropoxysilane, an n-hexyl tert-butoxysilane, an n-decyl trimethoxysilane, an n-decyl triethoxysilane, an n-decyl triisopropoxysilane, an n-decyl tri-tert-butoxysilane, an n-octadecyl trimethoxysilane, an n-octadecyl triethoxysilane, an n-octadecyl triisopropoxysilane, an n-octadecyl tri-tert-butoxysilane, a phenyl trimethoxysilane, a phenyl triethoxysilane, phenyl triisopropoxysilane, a phenyl tri tert-butoxysilane, a 3-glycidoxypropyl trimethoxysilane, a 3-glycidoxypropyl triethoxysilane, a 3-glycidoxypropyl triisopropoxysilane, a 3-glycidoxypropyl tri tert-butoxysilane, a 2-(3,4-epoxy cyclohexyl)ethyl trimethoxysilane, a 2-(3,4-epoxy cyclohexyl)ethyl triethoxy silane, a 2-(3,4-epoxy cyclohexyl)ethyl triisopropoxysilane, a 2-(3,4-epoxycyclohexyl) ethyl tri-tert-butoxysilane, a 3-(meth)acryloyloxypropyl trimethoxysilane, a 3-(meth)acryloyloxypropyl triethoxysilane, a 3-(meth)acryloyloxypropyl triisopropoxysilane, a 3-(meth)acryloyloxypropyl tri tert-butoxysilane, a 3-aminopropyl trimethoxysilane, a 3-aminopropyl triethoxysilane, a 3-aminopropyl triisopropoxysilane, a 3-aminopropyl tri tert-butoxysilane, a 3-mercaptopropyl trimethoxysilane, a 3-mercaptopropyl triethoxysilane, a 3-mercaptopropyl triisopropoxysilane, and a 3-mercaptopropyl tri tert-butoxysilane.

Examples of the tetrafunctional alkoxysilane compounds include a tetramethoxysilane, a tetraethoxysilane, a tetraisopropoxysilane, a tetra tert-butoxy silane, a dimethoxy diethoxy silane and the like.

Another example of the hydrolyzable silane compound than those represented by the formula (5) is a monofunctional hydrolyzable silane compound that has a single X⁵ bound to a silicon atom in the formula (5), which is difficult to form a film by itself, if such monofunctional hydrolyzable silane compound is combined with a hydrolyzable silane compound having two or more hydrolyzable groups.

### (5) Combination of Hydrolyzable Silane Compounds

The hydrolyzable silane compounds used in the manufacturing method of the embodiment according to the present invention may be one or more hydrolizable silane compounds selected from the above-mentioned hydrolyzable silane compounds depending upon the purpose, use and application, in consideration of film formability and durability, e.g., abrasion resistance, corrosion resistance, and weather resistance, as well as water repellency.

When the water repellent film is made from a fluorine-containing hydrolyzable silane compound, for which the manufacturing method of the embodiment according to the present invention is preferably used, an example of the preferred combination of the hydrolyzable silane compounds is a combination of a hydrolyzable silane compound having a fluorine-containing polyether group and, a hydrolyzable silane compound having a fluorine-containing alkyl group and/or a silane compound having a polydimethyl siloxane chain structure to which a fluorine-containing alkyl group is bound.

Hydrolyzable silane compounds have different reactivity depending on the type of the hydrolyzable group, which the hydrolyzable silane compound concerned possess. If a combination of a silane compound having a low reactivity and a silane compound having a high reactivity is used, without the addition of catalyst, then the hydrolysis reaction of the silane compound having a low reactivity may not proceed sufficiently. On the other hand, if the catalyst is added, then the hydrolysis dehydration condensation reaction of the silane compound having a high reactivity proceeds, and precipitation is likely to occur. As a result, the storage stability may be degraded. Thus, when a combination of a silane compound having low reactivity with the silane compound having a high reactivity is used, it is preferred that no catalyst is added.

Examples of the hydrolyzable group of the silane compound having a high reactivity are a chlorine atom and an isocyanate group, and an example of the hydrolyzable group of the silane compound having a low reactivity is an alkoxy group.

In the coated substrate manufacturing method of the embodiment according to the present invention, the coating film forming composition does not substantially contain a catalyst for hydrolysis reaction, and therefore the coating film forming composition is excellent in storage stability. In particular, the excellent storage stability is observed when a silane compound having a high reactivity is used in combination with a silane compound having a low reactivity.

Because the manufacturing method of the embodiment according to the present invention includes a catalyst treatment step, the hydrolysis reaction proceeds sufficiently even if the coating film forming composition does not substantially contain a catalyst for hydrolysis reaction. Thus, it is possible to obtain a coated substrate with a high durability.

For example, when a silane compound having an isocyanate group or a chlorine atom as a hydrolyzable group is used in combination with a silane compound having an alkoxy group as a hydrolyzable group, the content ratio of these two compounds in the coating film forming composition, i.e., a mass ratio of “the silane compound having an isocyanate group or a chlorine atom as the hydrolyzable group/the silane compound having an alkoxy group as a hydrolyzable group” is preferably 9/1 to 2/8, and particularly preferably 9/1 to 5/5. The alkoxy group having 1 to 10 carbon atoms is preferably used as the above-mentioned alkoxy group. A methoxy group and an ethoxy group are particularly preferable as the above-mentioned alkoxy group.

More preferably, the combination of the hydrolyzable silane compounds to which the manufacturing method of the embodiment according to the present invention is applied is a combination of a hydrolyzable silane compound having a perfluoropolyether group represented by the formula (1A) and a hydrolyzable silane compound having a perfluoroalkyl group represented by the formula (3).

Among the compounds (1A), the compound (1A-2) is preferred, and CF₃(OCF₂CF₂)ₐOCF₂CONHC₃H₆Si(OCH₃)₃ (“a” is 7 to 8, and the average value of “a” is 7.3) is particularly preferred.

Among the compounds (3), the compounds (3-1) are preferred. Among the compounds (3-1), C₆F₁₃CH₂CH₂Si(OCH₃)₃, C₈F₁₇CH₂CH₂Si(OCH₃)₃, C₆F₁₃CH₂CH₂SiCl₃, C₈F₁₇CH₂CH₂SiCl₃, C₆F₁₃CH₂CH₂Si(NCO)₃, and C₈F₁₇CH₂CH₂Si(NCO)₃ are particularly preferred.

If the content of the compound (1A) in the coating film forming composition is expressed, in terms of mass %, by Compound (1A)/(Compound (3)+Compound (1A))×100, i.e., the mass percentage of the compound (1A) to a total mass of the compounds (3) and (1A), the content of the compound (1A) is preferably 10 to 90 mass %, more preferably 10 to 60 mass %, and particularly preferably 10 to 30 mass %.

The content of the compound (3) in the coating film forming composition, which is expressed in terms of mass %, i.e., the mass percentage of the compound (3) to a total mass of the compounds (3) and (1A), is preferably 90 to 10 mass %, more preferably 40 to 90 mass %, and particularly preferably 70 to 90 mass %.

It should be noted that when the hydrolyzable silane compound(s) is (are) incorporated into the coating film forming composition, the hydrolyzable silane compound(s) may be incorporated as it is, or the hydrolyzable silane compound(s) may be incorporated in the form of a partially hydrolyzed condensate of the compound. Alternatively, a mixture of the hydrolyzable silane compound and its partially hydrolyzed condensate may be incorporated into the coating film forming composition.

When two or more kinds of hydrolyzable silane compounds are used in combination, the compounds may be contained in the coating film forming composition as they are, as partially hydrolyzed condensates thereof, or partially hydrolyzed co-condensate of two or more kinds of the compounds. Alternatively, the hydrolyzable silane compounds may be contained in the coating film forming composition as a mixture of the compounds, the partially hydrolyzed condensates and the partially hydrolyzed co-condensates. Hereinafter, the term “hydrolyzable silane compound(s)” may mean the compound itself and also mean partially hydrolyzed condensate and/or partially hydrolyzed co-condensate.

The partially hydrolyzed co-condensate of two or more kinds of hydrolyzable silane compounds is an oligomer (polymer), in which all or part of the hydrolyzable silyl group is hydrolyzed in a solvent in the presence of a catalyst such as an alkali catalyst or an acid catalyst, and the hydrolyzed silyl group is then dehydrated and condensated to the oligomer. The degree of condensation (degree of polymerization) of this partially hydrolyzed co-condensate is the extent to which a product is dissolved in a solvent.

The coating film forming composition used in the manufacturing method of the embodiment according to the present invention does not substantially contain a catalyst which catalyzes the hydrolysis reaction of the hydrolyzable silane compound. Therefore, when the partially hydrolyzed condensate and/or partially hydrolyzed co-condensate of hydrolyzable silane compound is contained in the coating film forming composition, the catalyst that is present in a reaction solution used to form the partially hydrolyzed condensate and/or partially hydrolyzed co-condensate of hydrolyzable silane compound should not be brought into the coating film forming composition.

If the coating-film-forming composition is prepared from a combination of two or more kinds of hydrolyzable silane compound, their partially hydrolyzed condensate and their partially hydrolyzed co-condensate, then the mass percentage of each hydrolyzable silane compound to a total mass of all the hydrolyzable silane compounds is a composition ratio (percentage) that is calculated using the amount of the hydrolyzable silane compound before the reaction. Thus, when the coating film forming composition contains a partially hydrolyzed co-condensate and partially hydrolyzed condensate, the composition ratios of the active components are decided based on the raw material composition.

### (Solvent)

The coating film forming composition used in the embodiment according to the present invention usually contains a solvent in order to ensure, for example, workability and quality of the resulting film when the coating film forming composition that contains the hydrolyzable silane compounds is applied on a substrate. The solvent may be any suitable solution as long as the solvent is able to dissolve the hydrolizable silane compounds to be used. Preferred examples of the solvent are alcohols, ethers, ketones, aromatic hydrocarbons, paraffinic hydrocarbons, and acetic esters. A particularly preferred example of the solvent is an organic solvent containing a fluorine atom (e.g., fluoroalcohol or fluorohydrocarbon). The solvent is not limited to one kind. For example, two or more kinds of solvent having different polarities and/or evaporation rates may be mixed and used as the solvent.

When the coating film forming composition contains a partly hydrolyzed condensates and partially hydrolyzed co-condensates, the coating film forming composition may contain a solvent that is used to prepare the partly hydrolyzed condensates and partially hydrolyzed co-condensates. This solvent may be the same as the solvent of the coating film forming composition.

The content of the solvent in the coating film forming composition is preferably 500 to 100,000 parts by mass, and particularly preferably 1,000 to 10,000 parts by mass, if the total mass of the hydrolyzable silane compounds is taken as 100 parts by mass. If the content of the solvent in the coating film forming composition is within the above-mentioned range, the coating film forming composition can easily be applied uniformly, and there is no possibility that uneven processing occurs in the applied film and also in the coating film.

### (Water)

The coating film forming composition may contain water to cause the contained hydrolyzable silane compound to be hydrolyzed and condensed. The content of the water in the coating film forming composition is preferably 10 to 50 parts by mass if the total mass of the hydrolyzable silane compounds is taken as 100 parts by mass. It should be noted that even if the coating film forming composition does not contain water, the coating film forming composition may take advantage of water contained in the atmosphere between when the applied film is formed and when the precursor film is present, for hydrolysis condensation of the hydrolyzable silane compound.

### (Other Components)

The coating film forming composition may contain suitable additives depending upon a given purpose, as long as such additives do not impair the effects and advantages of the embodiment according to the present invention. The additive is preferably selected in consideration of the compatibility or reactivity with the essential components. Preferred examples of the additive are ultra fine particles of metal oxides such as silica, alumina, zirconia, or titania, coloring materials such as pigments or dyes, antifouling materials, and various resins. The amount of the additive per 100 parts by mass of the solid content of the coating film forming composition (volatile components such as solvents are excluded) is preferably 0.01 to 20 parts by mass. The excessive addition of the additive to the coating film forming composition can lead to poor performance of the coating film obtained.

The coating film forming composition does not substantially contain a catalyst for hydrolysis reaction. The meaning of “does not substantially contain” is that the content of the catalyst for hydrolysis reaction to the total mass of the coating film forming composition is 0.01 mass % or less, when calculated after a catalyst produced as a reaction by-product from the contained hydrolyzable silane compounds is excluded. An example of the catalyst that is produced as a reaction by-product from the contained hydrolyzable silane compounds is a hydrochloric acid that is generated from a silane compound having a chlorine atom as a hydrolyzable group.

When the hydrolyzable silane compound is contained in the form of partially hydrolyzed condensates or partially hydrolyzed co-condensates, the catalyst for hydrolysis reaction that is used during the preparation of these condensates or co-condensates is removed from the condensates or co-condensates. It is, however, difficult to completely remove the catalyst for hydrolysis reaction, and therefore a very small amount of catalyst for hydrolysis reaction derived from the raw material may be contained in the coating film forming composition. Even in such a case, the content of the catalyst for hydrolysis reaction satisfies the above-mentioned condition of “does not substantially contain.” In other words, the partially hydrolyzed condensates or partially hydrolyzed co-condensates are included in the coating film forming composition such that the content of the catalyst for hydrolysis reaction relative to the total mass of the coating film forming composition, with the catalyst produced as a reaction by-product being excluded, is 0.01 mass % or less.

### (Preparation)

The coating film forming composition having a uniform composition is prepared by mixing predetermined amounts of hydrolyzable silane compound(s) and other components in a uniform composition.

In the manufacturing method of the embodiment according to the present invention, the coating film forming composition that is prepared in the above-described manner does not substantially contain a catalyst for hydrolysis reaction, and therefore the coating film forming composition is excellent in preservation stability.

### (B) Applying Step

Subsequent to the step (A), the coating film forming composition prepared in the step (A) is applied on the substrate to form the applied film.

The method of applying the coating film forming composition on the substrate is not limited to a particular method as long as the method can form a uniformly applied film. For example, brush coating, flow coating, spin coating, dip coating, squeegee coating, spray coating, die coating or hand coating may be used. One or more of these applying methods may be used to apply the coating film forming composition on the substrate as the applied film thickness is adjusted such that the ultimately obtained coating film has a desired thickness. Although the thickness of the coating film on the substrate is not limited to a particular value in the coated substrate manufacturing method of the embodiment according to the present invention, a thickness of 50 nm or less is preferred, and the lower limit is a thickness of a monomolecular layer. The coating film thickness is more preferably 1 nm to 30 nm, and particular preferably 1 nm to 20 nm.

The substrate on which the coating film is provided by the manufacturing method of the embodiment according to the present invention is not limited to a particular type of substrate as long as the substrate is made from a material on which the coating film is generally sought.

For example, the substrate may preferably be made from a metal, resin, glass, ceramic, or a combination of these materials (e.g., a composite material, a laminated material, etc.). A transparent substrate such as a resin substrate or a glass substrate is particularly preferred. Examples of the glass include ordinary soda lime glass, borosilicate glass, alkali-free glass, quartz glass, and the like. Among these, the soda lime glass is particularly preferred. Examples of the resin include the acrylic resins such as polymethyl methacrylate, the aromatic polycarbonate resins such as polyphenylene carbonate, and the aromatic polyester resins such as polyethylene terephthalate (PET).

The substrate may have a flat plate shape, or may have a curvature entirely or partially. The thickness of the substrate may be appropriately selected depending on the use of the coated substrate. In general, the substrate thickness is preferably 1 mm to 10 mm.

The surface of the substrate used in the embodiment according to the present invention may undergo an acid treatment (e.g., treatment with diluted hydrofluoric acid, sulfuric acid or hydrochloric acid), an alkali treatment (e.g., treatment with a sodium hydroxide solution), or a discharge treatment (e.g., treatment with plasma irradiation, corona irradiation, or electron ray irradiation) in accordance with the intended use. The substrate may have a various type of intermediate film provided on the surface of the substrate. For example, a deposited film, a sputtered film, or a film formed by a wet method or the like may be provided, as the intermediate film, on the surface of the substrate. If the substrate is a soda lime glass, it is preferred to provide the intermediate film for preventing elution of Na ions in terms of durability. If a glass substrate is produced by a float process, it is preferred to provide the coating film on the top surface, which has less surface tin, in terms of durability.

The intermediate film to be provided on the substrate surface, i.e., the intermediate film interposed between the substrate and the coating film may be an intermediate film that is mainly composed of silica, which is different from the coating film. For example, if the water repellent coating film of the substrate is prepared using a fluorine-containing hydrolyzable silane compound, then the intermediate film mainly composed of silica is preferably provided from the viewpoints of durability and adhesiveness. A preferred example of such intermediate film is an intermediate film formed by using a compound selected from a compound represented by the general formula (6), a partially hydrolyzed condensate thereof, and a perhydropolysilazane.

Si(X⁶)₄ (6)

In the formula (6), X⁶ represents a halogen atom, an alkoxy group or an isocyanate group, and one X⁶ may be the same as or different from other X⁶. Among these, X⁶ is preferably a chlorine atom, an alkoxy group having 1 to 4 carbon atoms, or an isocyanate group, and preferably four X⁶ are the same. Preferred examples of the compound (6) include Si(NCO)₄, Si(OCH₃)₄, and Si(OC₂H₅)₄.

The perhydropolysilazane is a cyclic or linear oligomer having a structure represented by —SiH₂—NH—SiH₂—, and the number of silicon atoms per molecule is preferably 2 to 500.

Alternatively, the intermediate film used in the coated substrate that has a water repellent coating film prepared from a fluorine-containing hydrolyzable silane compound may be an intermediate film mainly composed of silica, which is prepared from a combination of a compound selected from the compound (6), a partially hydrolyzed condensate thereof, and perhydropolysilazane, and a fluorine-containing hydrolyzable silane compound, e.g., a hydrolyzable silane compound having a perfluoroalkyl group such as the compound (3).

The intermediate film may be formed by a known method. Specifically, the intermediate film may be formed by applying onto the substrate surface a composition containing a solvent and a hydrolyzable silane compound for the intermediate film, and drying the composition to remove the solvent, and curing the composition. If the substrate has an intermediate film, the coating film forming composition is applied onto the surface of the intermediate film by the above-described method.

### (C) Drying Step

In the manufacturing method of the embodiment according to the present invention, the applied film prepared by the step (B) is dried prior to the next step (D) (i.e., catalyst treatment step) to obtain a precursor film. Here, the applied film refers to the film which has exactly the same component composition as the coating film forming composition applied on the substrate, and the precursor film refers to a film from which the solvent has been removed by drying and which is constituted by a different component composition from the coating film forming composition. In other words, if any volume of the solvent is removed from the applied film, then the applied film is called the “precursor film.”

The drying step is preferably carried out until 90 to 100 mass % of the solvent incorporated in the coating film forming composition is removed from the applied film. Particularly preferably, the solvent incorporated in the coating film forming composition is entirely removed by the drying step.

The conditions of the drying step depend on the amount and type of the solvent used in the preparation of the coating film forming composition as well as the thickness of the applied film and other factors. In this embodiment, for instance, the drying step is carried out by allowing the applied film to stand for 10 seconds to 10 minutes at 0° C. to 40° C.

It should be noted that even if the drying step is not intentionally performed, the solvent evaporation may occur naturally after the applied film is prepared. In such a case, it is assumed that the drying step is performed.

### (C-1) Humidifying Step

After the drying step, the catalyst treatment step is applied to the precursor film in the manufacturing method of the embodiment according to the present invention. In the manufacturing method of the embodiment according to the present invention, the humidifying step is preferably carried out between the drying step and the catalyst treatment step as described below. This is because the curing reaction of the hydrolyzable silane compound in the precursor film is facilitated or promoted in the humidifying step. The humidifying step is a step for humidifying the precursor film on the substrate obtained in the drying step at 0° C. to 60° C. for 10 minutes to 180 minutes. 20° C. to 40° C. is more preferred temperature, and 30 minutes to 120 minutes is more preferred time. The humidity is preferably 50 RH % to 100 RH %, and particularly preferably 60 RH % to 90 RH %.

Specifically, the humidifying step is carried out by holding the substrate having the precursor film thereon after the drying step for a predetermined time in a predetermined constant temperature and humidity chamber in which temperature and humidity are set to satisfy the above-mentioned conditions. In the manufacturing method of the embodiment according to the present invention, use of the catalyst treatment step is advantageous in forming the coating film cured to the same extent from the same material because the humidifying step can be ignored or the humidifying step may be carried out at approximately room temperature for only a very short time. Thus, this is advantageous in terms of productivity.

### (C-2) Heating Step

After the drying step in the manufacturing method of the embodiment according to the present invention, the catalyst treatment step as described below is performed on the precursor film. In the manufacturing method of the embodiment according to the present invention, the heating step is preferably performed between the drying step and the catalyst treatment step. This is because the heating step facilitates the curing reaction of the hydrolyzable silane compound in the precursor film. The heating step heats the precursor film on the substrate obtained in the drying step at over 60° C. and preferably up to 250° C. for 10 minutes to 180 minutes. 80° C. to 200° C. is a more preferred temperature, and 30 minutes to 60 minutes is more preferred time for the heating step.

It is to be noted that both the heating step and the humidifying step may be carried out between the step (C) and the step (D). When both the heating step and the humidifying step are carried out, the humidifying step is preferably preformed after the heating step because the humidifying step also serves as the cooling step of cooling the substrate. Performing the humidifying step after the heating step is also preferable because the humidifying step is carried out at high temperature and high humidity with the residual heat of the substrate from the heating step. This facilitates the hydrolysis.

### (D) Catalyst Treatment Step

After the drying step, the surface of the precursor film which has preferably undergone the humidifying step and/or heating step after the drying step, is treated with a treatment solution that contains a catalyst for hydrolysis reaction as its main component to obtain the coating film.

### (Treatment Solution)

The catalyst for hydrolysis reaction to be contained in the treatment solution is not particularly limited as long as the catalyst catalyzes the hydrolysis reaction of the hydrolyzable silane compound contained in the coating film forming composition. A specific example of the catalyst for hydrolysis reaction is an acid or alkali. Examples of the acid catalyst include a hydrochloric acid, a nitric acid, an acetic acid, a sulfuric acid, a phosphoric acid, a sulfonic acid, a methanesulfonic acid, and a paratoluenesulfonic acid. Examples of the alkali catalyst include a sodium hydroxide, a potassium hydroxide, an ammonia and the like.

Among them, the acid is preferable as the catalyst for hydrolysis reaction. The acid includes one or more selected from the group consisting of a hydrochloric acid, a nitric acid, a sulfuric acid, a paratoluenesulfonic acid, and a methanesulfonic acid. Among these, the paratoluenesulfonic acid is particularly preferable in view of the low residual to the precursor film surface and safety.

The content of the catalyst for hydrolysis reaction contained as a main component in the treatment solution is preferably 0.01 mass % to 5 mass % to the total mass of the treatment solution. If the content of the catalyst for hydrolysis reaction is in this range, the hydrolysis and condensation reactions of the hydrolyzable silane compound in the precursor film including the surface of the precursor film are facilitated, and it is possible to obtain the sufficiently cured coating film.

The treatment solution contains a solvent in addition to the catalyst for hydrolysis reaction. The solvent is a necessary component for the treatment solution in order to uniformly treat the precursor film surface with the catalyst for hydrolysis reaction. The solvent used in the treatment solution is not particularly limited as long as the solvent dissolves the catalyst for hydrolysis reaction. Because the solvent in the treatment solution must be ultimately removed in the catalyst treatment step, the boiling point of the solvent is preferably 60° C. to 160° C., and more preferably 60° C. to 120° C.

Preferred examples of the solvent include alcohols, ethers, ketones, acetic esters and the like. Specific example of the solvent satisfying the above-mentioned boiling point condition include isopropyl alcohol, ethanol, propylene glycol monomethyl ether, 2-butanone and the like. These may be used alone, or may be used in combination of two or more. The amount of solvent in the treatment solution is preferably 2,000 to 1,000,000 parts by mass relative to 100 parts by mass of the catalyst for hydrolysis reaction.

The treatment solution may also contain water. The water causes (allows) the hydrolyzable silane compound in the precursor film including the surface of the precursor film to hydrolyze and condense. Therefore, if the treatment solution contains water, the water is distinguished from the solvent. The amount of water in the treatment solution is preferably 50 to 15,000 parts by mass relative to 100 parts by mass of the catalyst for hydrolysis reaction. It should be noted that even if the treatment solution does not contain water, the precursor film may contain water and/or the water may be sufficiently present in the atmosphere. Then, such water may be used to cause the hydrolysis and condensation of the hydrolyzable silane compound. The treatment solution may contain additive(s) as desired, depending on the purpose, as long as the additive(s) may not impair the effects and advantages of the embodiment according to the present invention.

Because the purpose of using the treatment solution is to cause sufficient hydrolysis condensation reaction of the precursor film, it is preferred that the treatment solution does not substantially contain silane compounds. For example, it is preferred that the treatment solution does not substantially contain a tetramethoxysilane, a perfluoroalkyl alkyl trimethoxysilane and the like. The meaning of “does not substantially contain” is the same as above, i.e., the content is 0.01 mass % or less relative to the total treatment solution.

### (Treatment)

In the catalyst treatment step, the treatment solution is used to treat the surface of the precursor film on the substrate. The treatment of the precursor film surface is not particularly limited as long as the treatment solution at least contacts uniformly the entire surface of the precursor film. During the treatment of the precursor film surface, a liquid holding member that is impregnated with the treatment solution and holding it, is preferably moved while the liquid holding member is in pressure contact with the precursor film surface.

Preferably, the liquid holding member is configured to be able to move as the liquid holding member is pressed with a certain (or constant) pressure such that the liquid holding member supplies the precursor film surface with an appropriate amount of the treatment solution, which is impregnated and held in the liquid holding member. Also, the liquid holding member is preferably configured such that after the movement of the liquid holding member, the treatment solution does not remain visually on the precursor film surface.

If the supply amount of the treatment solution to the precursor film surface is expressed by the volume per unit surface area of the precursor film, then the supply amount of the treatment solution is preferably 0.01 mL/m² to 20 mL/m² and more preferably 0.1 mL/m² to 20 mL/m². The pressure is preferably 200 Pa to 5,000 Pa, and the moving speed is preferably 0.01 m/sec to 10 m/sec. Although pressing and moving the liquid holding member may be performed by human hands, it is preferred that the pressing and moving is performed by a controllable device that can keep the moving speed and the pressure at constant values respectively.

The preferred temperature condition of the catalyst treatment step is to perform the catalyst treatment at 0° C. to 40° C. If the treatment temperature is less than 0° C., there is a risk of causing freezing of residual moisture after treatment, and there may be a decrease in the hydrolysis effect. If the treatment temperature is higher than 40° C., there may be a reduction of workability because evaporation of the solvent may take place faster. The time of the catalyst treatment is preferably 5 seconds to 5 minutes. If the time of the catalyst treatment is less than 5 seconds, there is a possibility that a certain portion is not treated. If the time of the catalyst treatment exceeds five minutes, this process may be subject to rate-limiting and the productivity may drop.

A specific example of the material of the liquid holding member is sponges, nonwoven fabric, woven fabric, or paper. The liquid holding member may be a commercially available product. For example, the liquid holding member is Kimwipes L-100 (trade name, manufactured by Nippon Paper Crecia Co., Ltd.) or the like.

In this manner, the hydrolyzable silane compound in the precursor film hydrolyzes and condenses from the precursor film surface during the catalyst treatment step, and therefore the hydrolyzable silane compound cures. As a result, the substrate having the coating film thereon, i.e., the coated substrate, is obtained.

It should be noted that after the catalyst treatment step (D), another humidifying step may be performed under appropriate conditions in order to further facilitate the curing reaction of the hydrolyzable silane compound, if necessary.

Although the thickness of the coating film to be provided on the substrate by the manufacturing method of the embodiment according to the present invention is not limited to a particular value, the thickness of 50 nm or less is preferred. The lower limit of the coating film thickness is the thickness of the monomolecular layer. The thickness of the coating film on the substrate is more preferably 1 nm to 30 nm, and particularly preferably 1 nm to 20 nm.

The coating film, e.g., the water-repellent film, obtained by the manufacturing method of the embodiment according to the present invention can be used for automobile window glass, architectural window glass or the like.

The method of providing the substrate with a coating film, i.e., the method of manufacturing the coated substrate according to the embodiment of the present invention, ensures the storage stability of the it is possible to obtain the sufficiently cured coating film forming composition to be used, is easy to carry out, has high production efficiency, does not deteriorate the substrate, imparts the substrate a good appearance, and ensures high durability.

### EXAMPLES

Now, examples of the present invention will be shown below. It should be noted, however, that the present invention is not limited to these examples. It should also be noted that Examples 1 to 12 are examples, and Examples 13 to 16 are comparative examples.

A coated substrate, i.e., the substrate having a water-repellent coating film thereon, is referred to as “water repellent film-coated substrate” in the following description. Water repellent film-coated substrates were prepared in the Examples 1 to 16. The evaluations of the respective water repellent film-coated substrates were carried out in the below-described manner.

### <Repellency>

The repellency was evaluated in terms of the water contact angle (CA) measured by the following method. Firstly, the initial values were measured prior to performing the below-described tests.

### [Water Contact Angle (CA)]

The contact angle of a water droplet with a diameter of 1 mm, which was placed on the water repellent film surface of the water repellent film-coated substrate, was measured using a CA-X150 (Kyowa Interface Science Co., Ltd.). The measurement was performed at 5 different positions on the water repellent film surface, and the average value was calculated.

### <Weather Resistance>

### [Outdoor Exposure Test]

An outdoor exposure test was carried out in accordance with JISZ2381. Specifically, the water repellent film-coated substrate was installed outdoors with the water repellent film surface facing the south at an angle of 30 degrees with respect to the horizon. When three months passed after the start of the test, the water contact angle was measured by the above-described method. If the water contact angle (CA) was 90 degrees or more after the test, the water repellent film-coated substrate passed the weather resistance test and the good mark “O” was given whereas if the water contact angle (CA) was smaller than 90 degrees, then the water repellent film-coated substrate failed the weather resistance test and the no good mark “X” was given.

### <Corrosion Resistance>

### [Neutral Salt Spray Test]

A neutral salt stray test was performed in accordance with JISZ2371. Specifically, the water repellent film-coated substrate was installed with the water-repellent film surface facing upward at an angle of 20 degrees with respect to the horizon. Then, the aqueous solution of sodium chloride with 5 mass % concentration, which was adjusted in the range of pH6.5 to pH7.2, was sprayed to the water repellent film-coated substrate for 300 hours in an atmosphere of 35° C. Subsequently, the water contact angle was measured by the above-described method. If the water contact angle (CA) was 55 degrees or more after the test, then the water repellent film-coated substrate passed the corrosion resistance test and the good mark “O” was given whereas if the water contact angle was less than 55 degrees, then the water repellent film-coated substrate failed the corrosion resistance test and the no good mark “X” was given.

The following abbreviations were used for the compounds in the respective examples.

### <Compound (3)>

Compound (3-1): C₆F₁₃C₂H₄SiCl₃ (manufactured by Tokyo Chemical Industry Co., Ltd.)

### Compound (3-5): C₆F₁₃C₂H₄Si(NCO)₃

### (Example of Synthesis of Compound (3-5))

Journal of Fluorine Chemistry 79 (1996) 87-91 was looked at, and 21.5 g of C₆F₁₃C₂H₄SiCl₃ and 25.0 g of silver cyanate were used as the raw materials. The raw materials were stirred in a benzene solvent at 80° C. for one hour for synthesis. The resultant was refined, and 17.3 g of the compound (3-5) was obtained which was liquid at room temperature.

### <Compound (1A)>

### Compound (1A-21): CF₃O(CF₂CF₂O)ₐCF₂CONHC₃H₆Si(OCH₃)₃

In the compound (1A-21), “a” is 7 to 8, and its average value is 7.3.

The compounds (1A-21) were compounds that were obtained by the below-mentioned example of synthesis. The following abbreviations were used for the compounds.

R-225: dichloropenta fluoropropane

### R^{F2}: —CF(CF₃)OCF₂CF(CF₃)OCF₂CF₂CF₃

### R-113: CCl₂FCClF₂

### (Example of Synthesis of the Compound (1A-21))

Into a flask, 25 g of CH₃O(CH₂CH₂O)ₐCH₂CH₂OH (commercially available polyoxyethylene glycol monomethyl ether; “a” is 7 to 8 and its average is 7.3), 20 g of R-225, 1.2 g of NaF and 1.6 g of pyridine were put. While the flask inner temperature was maintained to 10° C. or lower, the substances in the flask were stirred vigorously to cause the bubbling of nitrogen. 46.6 g of FC(O)—R^{F2} was added dropwise into the flask for 3.0 hours while maintaining the flask inner temperature at 5° C. or lower. After completion of the dropwise addition, the mixture was stirred for 12 hours at 50° C., followed by stirring at room temperature for 24 hours. Then, a crude liquid was collected. The crude liquid underwent the filtration at a reduced pressure, and the collected crude liquid was dried 12 hours in a vacuum dryer at 50° C. and 5.0 torr to obtain a crude liquid. This crude liquid was dissolved in 100 mL of R-225, was washed three times with 1000 mL of saturated sodium bicarbonate water, and the organic phase was collected. 1.0 g of magnesium sulfate was added to the organic phase, and the mixture was stirred for 12 hours. Then, magnesium sulfate was removed by pressure filtration, and the R-225 was removed from the recovered liquid by an evaporator. As a result, 56.1 g of the compound which was liquid at room temperature, i.e., CH₃O(CH₂CH₂O)ₐCH₂CH₂OC(O)—R^{F2} (“a” is 7 to 8, and its average is 7.3) was obtained.

1560 g of R-113 was put and stirred in 3000 mL of Hastelloy autoclave, and it was maintained at 25° C. To the autoclave gas outlet, a cooler kept to 20° C., an NaF pellet packed layer, and another cooler kept to −20° C. are connected in series. A liquid return line is connected for returning to the autoclave the condensed liquid from the cooler maintained to −20° C. After nitrogen gas was blown into the autoclave for 1.0 hour, fluorine gas diluted to 10% with nitrogen gas (hereinafter referred to as 10% fluorine gas) was blown at a flow rate of 24.8 L/hour for one hour. Then, while blowing the 10% fluorine gas into the autoclave at the same flow rate, a solution (27.5 g of CH₃O(CH₂CH₂O)ₐCH₂CH₂OC(O)—R^{F2} was dissolved in 1350 g of R-113) was injected over 30 hours. Subsequently, while the 10% fluorine gas was blown into the autoclave at the same flow rate, 12 mL of R-113 was injected. During this injection, the inner temperature was changed to 40° C. Then, 6 mL of R-113 solution with 1 mass % benzene being dissolved was injected. In addition, fluorine gas was blown for 1.0 hour, and nitrogen gas was blown for 1.0 hour. Upon completion of the reaction, the solvent was distilled off by vacuum drying (60° C. and 6.0 hours), 45.4 g of compounds (CF₃O(CF₂CF₂O)ₐCF₂CF₂OC(O)—R^{F2} (a=7 to 8, and its average value is 7.3)) was obtained, which was liquid at room temperature.

A 300 mL of eggplant flask in which a stirrer chip was placed was thoroughly purged with nitrogen. In the eggplant flask, 40 g of ethanol, 5.6 g of NaF, and R-225 (50 g) were put. After 43.5 g of CF₃O(CF₂CF₂O)ₐCF₂CF₂OC(O)—R^{F2} was dripped in the eggplant flask, stirred vigorously while carrying out bubbling at room temperature. The eggplant flask exit was sealed with nitrogen. After eight hours passed, a vacuum pump was connected through the cooling tube to maintain the system at a reduced pressure. This distilled off the excessive ethanol and CH₃CH₂OC(O)—R^{F2} produced by ester exchange. After 24 hours, 26.8 g of compound, i.e., CF₃O(CF₂CF₂O)ₐCF₂C(O)OCH₂CH₃ (“a” is 7 to 8, and its average value is 7.3), resulted. This compound was liquid at room temperature.

33.1 g of CF₃O(CF₂CF₂O)ₐCF₂C(O)OCH₂CH₃ and 3.7 g of NH₂CH₂CH₂CH₂Si(OCH₃)₃ were put into a 100 mL of round bottom flask, and the mixture was stirred for 2 hours at room temperature. After completion of the reaction, unreacted NH₂CH₂CH₂CH₂Si(OCH₃)₃ and ethanol by-product were distilled off under reduced pressure, and 32.3 g of compound (1A-21) resulted. This compound was liquid at room temperature.

### <Compound (6)>

Compound (6-1): Si(NCO)₄ (SI-400, trade name, manufactured by Matsumoto Fine Chemical Co., Ltd.)

[1] Preparing Treatment Solution (F) Containing Catalyst for Hydrolysis Reaction

A treatment solution (F) which is used in the catalyst treatment step, i.e., step (D) being performed in the examples relating to the manufacture of the water-repellent film-coated substrate as described below, and which contains the catalyst for hydrolysis reaction as its main component was prepared as follows.

### Preparation Example 1-1

In a glass vessel equipped with a stirrer and a thermometer, 96.98 g of isopropyl alcohol (Junsei Chemical Co., Ltd.), 3.00 g of distilled water (Wako Pure Chemical Industries, Ltd.), and 0.02 g of paratoluenesulfonic acid monohydrate (Wako Pure Chemical Industries, Ltd.) were put. The mixture was stirred for 1 hour at 25° C. to obtain the treatment solution (F1) to be used in the step (D). The content of paratoluenesulfonic acid in the treatment solution (F1) is 0.018 mass %.

### Preparation Example 1-2

In a glass vessel equipped with a stirrer and a thermometer, 96.95 g of isopropyl alcohol (Junsei Chemical Co., Ltd.), 3.00 g of distilled water (Wako Pure Chemical Industries, Ltd.), and 0.05 g of paratoluenesulfonic acid monohydrate (Wako Pure Chemical Industries, Ltd.) were put. The mixture was stirred for 1 hour at 25° C. to obtain the treatment solution (F2) to be used in the step (D). The content of paratoluenesulfonic acid in the treatment solution (F2) is 0.045 mass %.

### Preparation Example 1-3

In a glass vessel equipped with a stirrer and a thermometer, 96.90 g of isopropyl alcohol (Junsei Chemical Co., Ltd.), 3.00 g of distilled water (Wako Pure Chemical Industries, Ltd.), and 0.10 g of paratoluenesulfonic acid monohydrate (Wako Pure Chemical Industries, Ltd.) were put. The mixture was stirred for 1 hour at 25° C. to obtain the treatment solution (F3) to be used in the step (D). The content of paratoluenesulfonic acid in the treatment solution (F3) is 0.09 mass %.

### Preparation Example 1-4

In a glass vessel equipped with a stirrer and a thermometer, 96.80 g of isopropyl alcohol (Junsei Chemical Co., Ltd.), 3.00 g of distilled water (Wako Pure Chemical Industries, Ltd.), and 0.20 g of paratoluenesulfonic acid monohydrate (Wako Pure Chemical Industries, Ltd.) were put. The mixture was stirred for 1 hour at 25° C. to obtain the treatment solution (F4) to be used in the step (D). The content of paratoluenesulfonic acid in the treatment solution (F4) is 0.18 mass %.

### Preparation Example 1-5

In a glass vessel equipped with a stirrer and a thermometer, 96.50 g of isopropyl alcohol (Junsei Chemical Co., Ltd.), 3.00 g of distilled water (Wako Pure Chemical Industries, Ltd.), and 0.50 g of paratoluenesulfonic acid monohydrate (Wako Pure Chemical Industries, Ltd.) were put. The mixture was stirred for 1 hour at 25° C. to obtain the treatment solution (F5) to be used in the step (D). The content of paratoluenesulfonic acid in the treatment solution (F5) is 0.45 mass %.

### Preparation Example 1-6

In a glass vessel equipped with a stirrer and a thermometer, 96.00 g of isopropyl alcohol (Junsei Chemical Co., Ltd.), 3.00 g of distilled water (Wako Pure Chemical Industries, Ltd.), and 1.00 g of paratoluenesulfonic acid monohydrate (Wako Pure Chemical Industries, Ltd.) were put. The mixture was stirred for 1 hour at 25° C. to obtain the treatment solution (F6) to be used in the step (D). The content of paratoluenesulfonic acid in the treatment solution (F6) is 0.9 mass %.

### Preparation Example 1-7

In a glass vessel equipped with a stirrer and a thermometer, 92.00 g of isopropyl alcohol (Junsei Chemical Co., Ltd.), 3.00 g of distilled water (Wako Pure Chemical Industries, Ltd.), and 5.00 g of paratoluenesulfonic acid monohydrate (Wako Pure Chemical Industries, Ltd.) were put. The mixture was stirred for 1 hour at 25° C. to obtain the treatment solution (F7) to be used in the step (D). The content of paratoluenesulfonic acid in the treatment solution (F7) is 4.5 mass %.

### Preparation Example 1-8

In a glass vessel equipped with a stirrer and a thermometer, 96.72 g of isopropyl alcohol (Junsei Chemical Co., Ltd.), 3.00 g of distilled water (Wako Pure Chemical Industries, Ltd.), and 0.28 g of 36 mass % concentrated hydrochloric acid (Wako Pure Chemical Industries, Ltd.) were put. The mixture was stirred for 1 hour at 25° C. to obtain the treatment solution (F8) to be used in the step (D). The content of hydrochloric acid in the treatment solution (F8) is 0.1 mass %.

### Preparation Example 1-9

In a glass vessel equipped with a stirrer and a thermometer, 96.83 g of isopropyl alcohol (Junsei Chemical Co., Ltd.), 3.00 g of distilled water (Wako Pure Chemical Industries, Ltd.), and 0.17 g of 60 mass % concentrated nitric acid (Wako Pure Chemical Industries, Ltd.) were put. The mixture was stirred for 1 hour at 25° C. to obtain the treatment solution (F9) to be used in the step (D). The content of nitric acid in the treatment solution (F9) is 0.1 mass %.

### Preparation Example 1-10

In a glass vessel equipped with a stirrer and a thermometer, 97.00 g of isopropyl alcohol (Junsei Chemical Co., Ltd.) and 3.00 g of distilled water (Wako Pure Chemical Industries, Ltd.) were put. The mixture was stirred for 1 hour at 25° C. to obtain the treatment solution (F 10) to be used in the step (D) for comparison.

[2] Preparation of Intermediate Film Forming Composition (E)

Preparation examples of the intermediate film forming composition (E) that were used in the examples relating to the manufacture of the water-repellent film-coated substrate as described below, are shown below.

### Preparation Example 2-1

In a glass vessel equipped with a stirrer and a thermometer, 9.70 g of butyl acetate (Junsei Chemical Co., Ltd.) and 0.30 g of compound (6-1) were put. The mixture was stirred for 30 minutes at 25° C. to obtain a liquid composition (E1) for an intermediate film.

### Preparation Example 2-2

In a glass vessel equipped with a stirrer and a thermometer, 9.50 g of butyl acetate (Junsei Chemical Co., Ltd.), 0.40 g of compound (6-1) and 0.10 g of compound (3-5) were put. The mixture was stirred for 30 minutes at 25° C. to obtain a liquid composition (E2) for an intermediate film.

### Examples 1 to 16

### Production of Water-Repellent Film-Coated Substrate and Evaluation of Them

The intermediate film forming compositions (E) and treatment solutions (F) obtained in the above-described Preparation Examples were used to manufacture water-repellent film-coated substrates by the steps (A) to (D).

### Step (A): Coating Film (Water Repellent Film) Forming Composition (H) Preparation Step

In a glass vessel equipped with a stirrer and a thermometer, 3.10 g of butyl acetate (Junsei Chemical Co., Ltd.), 12.39 g of hydrofluoroether (AE3000, trade name, manufactured by Asahi Glass Co., Ltd.), 0.936 g of compound (3-1), and 0.234 g of compound (1A-21) were put. The mixture was stirred for 30 minutes at 25° C. to obtain a liquid composition (H1). This liquid composition (H1) was a coating film (water repellent coating film) forming composition, and used in all of the examples (Examples 1 to 16).

The coating film (water repellent film) forming composition (H1) was stored in an atmosphere at 25° C. for 24 hours, but no significant precipitation occurred. Thus, the good storage stability was confirmed.

### Step (B): Applying Step

A washed soda lime glass substrate (5 degree water contact angle; 300 mm×300 mm×3 mm thick) was used as the substrate in each of the Examples. The surface of the soda lime glass substrate was polished and cleaned with cerium oxide, and dried. In the Examples shown in Table 1, 2 g of intermediate film forming liquid composition (E1) or (E2) was applied on the substrate surface by the squeegee coating method. Then, the substrate surface was air-dried.

In all of the Examples 1 to 16, 2 g of coating film (water repellent film) forming composition (H1) obtained in the step (A) was applied on the surface of the intermediate film of the intermediate film-coated glass substrate obtained, by the squeegee coating method.

### Step (C): Drying Step

In all the examples (Examples 1 to 16), after the step (B), the glass substrate on which the coating film (water repellent film) forming composition (H1) had been applied was left five minutes at room temperature (25° C.) such that the applied film was dried to obtain a precursor film.

### Step (C-1): Humidifying Step

In Examples 1-3, Examples 5-9, Examples 11-13 and Example 15, after the step (C), the glass substrate having the precursor film thereon was kept in a constant-temperature and constant-humidity vessel at 25° C. at 80 RH % for one hour. In Example 4, 10, 14 and 16, the step (D) as described below, was performed without performing the step (C-1).

### Step (D): Catalyst Treatment Step

After the step (C-1), which related to Examples 1-3, Examples 5-9, Examples 11-13 and Example 15, or after the step (C), which related to Examples 4, 10, 14 and 16, the surface of the precursor film applied on the glass substrate was wiped up with a KIMWIPE-L100 (tradename, manufactured by Nippon Paper Crecie, Co., Ltd.) impregnated with 2 g of treatment solution (F1) to (F9) containing the acid catalyst, which was prepared as described above, or with 2 g of treatment solution (F10) containing no catalyst at room temperature, as shown in Table 1. The wiping pressure was 1,000 Pa and the wiping speed was 1.5 msec. As a result, the substrate having the coating film (water repellent film) thereon was obtained. The treatment solution was supplied to the surface of the precursor at 15 mL/m². In this manner, the coated substrates 1 to 16 having the water repellent film were obtained in Examples 1 to 16. Table 1 shows the intermediate film forming composition used in the step (B), the coating film (water repellent film) forming composition used in the step (B), the treatment solution used in the catalyst treatment of the step (D), and use/no use of the humidifying step (C-1).

TABLE 1

| | | Composition and Solution Used in the Manufacturing Method | | | | | |
|---|---|---|---|---|---|---|---|
| | | Intemediate | Coating Film | | | | |
| | | Film | (Water Repellent | Treatment Solution | | | |
| | Coated | Forming | Film) Forming | | | Content | Step |
| Example | Substrate | Composition | Composition | type | Catalyst | (Mass %) | (C-1) |
| 1 | 1 | E1 | H1 | F1 | Paratoluensulfonic Acid | 0.018 | Used |
| 2 | 2 | E1 | H1 | F2 | Paratoluensulfonic Acid | 0.045 | Used |
| 3 | 3 | E1 | H1 | F3 | Paratoluensulfonic Acid | 0.09 | Used |
| 4 | 4 | E1 | H1 | F3 | Paratoluensulfonic Acid | 0.09 | Not |
| | | | | | | | Used |
| 5 | 5 | E1 | H1 | F8 | Hydrochloric Acid | 0.1 | Used |
| 6 | 6 | E1 | H1 | F9 | Nitric Acid | 0.1 | Used |
| 7 | 7 | E1 | H1 | F4 | Paratoluensulfonic Acid | 0.18 | Used |
| 8 | 8 | E1 | H1 | F5 | Paratoluensulfonic Acid | 0.45 | Used |
| 9 | 9 | E2 | H1 | F3 | Paratoluensulfonic Acid | 0.09 | Used |
| 10 | 10 | E2 | H1 | F3 | Paratoluensulfonic Acid | 0.09 | Not |
| | | | | | | | Used |
| 11 | 11 | E2 | H1 | F6 | Paratoluensulfonic Acid | 0.9 | Used |
| 12 | 12 | E2 | H1 | F7 | Paratoluensulfonic Acid | 4.5 | Used |
| 13 | 13 | E1 | H1 | F10 | — | — | Used |
| 14 | 14 | E1 | H1 | F10 | — | — | Not |
| | | | | | | | Used |
| 15 | 15 | E2 | H1 | F10 | — | — | Used |
| 16 | 16 | E2 | H1 | F10 | — | — | Not |
| | | | | | | | Used |

### Durability Evaluation Results

The coated substrate 1-16 having the coating film (water repellent film) obtained in each of Examples 1-16 was evaluated for durability by the above-described evaluation method. Table 2 shows the weather resistance evaluation results, and Table 3 shows the corrosion resistance evaluation results.

TABLE 2

| | Evaluation Results | | |
|---|---|---|---|
| Coated | Water Cotanct Angle (degrees) [°] | | Weather Resistance |
| Substrate | Initial Angle | After Exposure Test | Evaluation |
| 1 | 108 | 99 | ◯ |
| 2 | 108 | 100 | ◯ |
| 3 | 108 | 99 | ◯ |
| 4 | 108 | 91 | ◯ |
| 5 | 108 | 102 | ◯ |
| 6 | 108 | 103 | ◯ |
| 7 | 108 | 102 | ◯ |
| 8 | 108 | 102 | ◯ |
| 9 | 107 | 95 | ◯ |
| 13 | 108 | 80 | X |
| 14 | 108 | 72 | X |

TABLE 3

| | Evaluation Results | | |
|---|---|---|---|
| Coated | Water Cotanct Angle (degrees) [°] | | Corrosion Resistance |
| Substrate | Initial Angle | After Spray Test | Evaluation |
| 9 | 107 | 71 | ◯ |
| 10 | 107 | 56 | ◯ |
| 11 | 107 | 72 | ◯ |
| 12 | 107 | 73 | ◯ |
| 15 | 107 | 43 | X |
| 16 | 107 | 36 | X |

It is understood from Table 2 and Table 3 that the coated substrates 1 to 12 having a coating film (water repellent film) obtained by the manufacturing method of the embodiment according to the present invention had good durability in terms of the weather resistance and the corrosion resistance. On the other hand, the coated substrates 13 to 16 having a coating film (water repellent film) obtained with the treatment solution containing no catalyst for hydrolysis reaction had poor durability in terms of the weather resistance and corrosion resistance. Among the coated substrates 1 to 12 having the coating film (water repellent film) made by the manufacturing method of the invention, the Examples 1 to 3, Examples 5 to 9, Examples 11 and 12 obtained with the humidifying step (C-1) had a particularly high durability.

What is claimed is:

1. A method of manufacturing a coated substrate having a coating film on a substrate, the method comprising the steps of:
preparing a coating film forming composition containing at least one kind of silane compound having a hydrolyzable functional group, and not substantially containing a catalyst for hydrolysis reaction;
applying the coating film forming composition on the substrate to form an applied film on the substrate;
drying the applied film to obtain a precursor film; and
treating a surface of the precursor film with a treatment solution to make the coating film on the substrate, the treatment solution containing a catalyst for hydrolysis reaction as a main component.

2. The method of manufacturing a coated substrate according to claim 1, wherein the catalyst for hydrolysis reaction is an acid or alkali.

3. The method of manufacturing a coated substrate according to claim 1, wherein the catalyst for hydrolysis reaction is an acid.

4. The method of manufacturing a coated substrate according to claim 2, wherein the acid includes at least one acid selected from the group consisting of hydrochloric acid, nitric acid, sulfuric acid, paratoluenesulfonic acid, and methanesulfonic acid.

5. The method of manufacturing a coated substrate according to claim 1, wherein the silane compound having the hydrolyzable functional group is a silane compound having a structure selected from a perfluoroalkyl group, a perfluoropolyether group and a polydimethylsiloxane chain.

6. The method of manufacturing a coated substrate according to claim 1, wherein the hydrolyzable functional group is selected from an alkoxy group having 1 to 10 carbon atoms, an isocyanate group and a chlorine atom.

7. The method of manufacturing a coated substrate according to claim 1, wherein the silane compound having the hydrolyzable functional groups includes a silane compound having a chlorine atom or an isocyanate group as the hydrolyzable functional group, and a silane compound having an alkoxy group as the hydrolyzable functional group.

8. The method of manufacturing a coated substrate according to claim 1, wherein the treatment solution does not substantially contain a silane compound.

9. The method of manufacturing a coated substrate according to claim 1, wherein the step of treating the surface of the precursor film with the treatment solution is carried out by moving a liquid holding member while the liquid holding member being in press contact with the surface of the precursor film, the liquid holding member being impregnated with the treating solution and holding the treating solution.

10. The method of manufacturing a coated substrate according to claim 9, wherein a material of the liquid holding member is selected from a sponge, nonwoven fabric, woven fabric and paper.

11. The method of manufacturing a coated substrate according to claim 1 further including the step of humidifying the precursor film at 0° C. to 60° C. and 50 RH % to 100 RH % for 10 minutes to 180 minutes prior to the step of treating the surface of the precursor film.

12. The method of manufacturing a coated substrate according to claim 1, wherein a material of the substrate is a resin or glass.
